(19) United States
(12) Patent Application Publication
(10) Pub. No.: US 2022/0144591 A1
(43) Pub. Date: May 12, 2022

(54) ELEVATOR SYSTEM HAVING TWO ELEVATOR CARS IN A COMMON SHAFT

(71) Applicant: TK Elevator Innovation and Operations GmbH, Duesseldorf (DE)

(72) Inventor: Tobias WENZELBURGER, Stuttgart (DE)

(73) Assignee: TK Elevator Innovation and Operations GmbH, Duesseldorf (DE)

(21) Appl. No.: 17/310,070

(22) PCT Filed: Jan. 9, 2020
(86) PCT No.: PCT/EP2020/050359

§ 371 Date: Jul. 14, 2021

(30) Foreign Application Priority Data
Jan. 15, 2019 (DE) 10 2019 200 375.3

(51) Int. Cl. B66B 11/00; B66B 11/04; B66B 7/06

(52) U.S. Cl. CPC B66B 11/0095; B66B 11/009; B66B 2201/307; B66B 7/06; B66B 11/04

(57) ABSTRACT

An elevator installation includes a first elevator car disposed in a shaft and connected to a counterweight by a first suspension having a first suspension means section, and a second suspension having a second suspension means section. A drive unit moves the elevator car by means of the first suspension. The elevator installation also includes a second elevator car that is movable in the shaft, independently of the first elevator car, via a second drive unit.

The invention relates to an elevator installation having an elevator car which is arranged in a shaft and which is connected to a counterweight. The connection comprises a first suspension having a first suspension means section. The connection further comprises a second suspension having a second suspension means section. Exemplary embodiments show an alternative 1:1 suspension of an elevator car in an elevator installation.

Nowadays, usable space and living space, especially in tall buildings, is becoming more and more valuable and expensive. Elevator installations that take up a lot of space therefore cost the owner of the building a lot of money, since the space that the elevator installation takes up cannot be rented out. In the case of rope-operated elevator installations, due to the design, there is a need to arrange a traction sheave or drum at the (upper) end of the elevator shaft, over which traction sheave or drum the rope is guided to move the elevator car. The rope is often also connected to a counterweight after it has been guided over the traction sheave. This suspension of the elevator car requires space in the building. Depending on the design of the elevator installation, the suspension and the drive machine can quickly occupy several floors. This is true especially, but not exclusively, for multi-cabin elevator systems. Furthermore, the ratio between electrical and mechanical power of the drive unit can be varied by means of a suitable selection of the suspension. In this way, in the case of the selection of a suitable suspension, the drive unit can, for example with the same electrical power consumption, be of smaller configuration, in particular in the region of the drive shaft, which in turn can save space.

The object of the present invention is therefore to provide an improved concept for the suspension of an elevator installation.

The object is achieved by the subject matter of the independent patent claims. Further advantageous embodiments are the subject matter of the dependent patent claims.

Exemplary embodiments show an elevator installation having an elevator car which is arranged in a shaft and which is connected to a counterweight. The connection between the elevator car and the counterweight comprises a first suspension, in particular a 1:1 suspension, which has a first suspension means section. The connection between the elevator car and the counterweight further comprises a second suspension, in particular a 1:1 suspension, which has a second suspension means section. In the design of a 1:1 suspension, the first suspension is also described as a first 1:1 suspension, and analogously the second suspension as a second 1:1 suspension.

The possibility of suspending the elevator car by means of two different suspensions makes it possible for the advantages of suspensions with larger transmission ratios to be obtained through two suspensions with lower transmission ratios, without having to accept the disadvantages of the larger transmission ratios. For example if both the first and the second suspension are designed as a 1:1 suspension. With such a suspension of the elevator car and the counterweight, the advantages of a 1:1 suspension and of a 2:1 suspension can be combined. The advantages of the 1:1 suspension are based in particular on making it possible to guide the suspension means from the elevator car to the counterweight with as few reverse bending cycles as possible, in particular no reverse bending cycles, in a small installation space. One advantage of the 2:1 suspension is that, with the same electrical power consumption, a mechanical design of the drive unit, in particular of the drive shaft, can be reduced in size. This means that the drive unit of a structurally identical elevator installation can be smaller (in spatial terms) when using a 2:1 suspension than when a 1:1 suspension is used. As a result, the use of two 1:1 suspensions between the elevator car and the counterweight makes it possible to enable both a lower overall height for the suspension and a smaller dimensioning of the drive unit from a mechanical point of view.

Similar effects can be achieved with other combinations of suspensions, especially when changing from one larger transmission ratio to two smaller transmission ratios. According to this disclosure, a 2:1 suspension has a larger transmission ratio than a 1:1 suspension. Further possible transmission ratios are 3:1, 4:1 or other larger transmission ratios. In the context of this disclosure, a larger transmission ratio is also described as a higher-ratio suspension.

Exemplary embodiments show that the second suspension has the absence of a drive. In other words, only the first suspension is driven by the drive unit. Along the second suspension, the elevator car moves on account of its own inherent weight or the inherent weight of the counterweight. It is thus furthermore the case that, although the car is suspended by means of two suspensions, only one drive is required to move the elevator car. This in turn means a considerable reduction in the installation space required, that is to say a significant saving in space, compared with the use of two drive units to move the elevator car.

In alternative exemplary embodiments, the elevator installation has a further drive unit which is designed to drive the second suspension and to move the elevator car in cooperation with the drive unit. The drive unit can thus again be of smaller dimensions, with the further drive unit naturally also taking up space. The cooperation of the two drive units is to be understood such that they are operated synchronously. In this way, for example unnecessary stresses in the suspension means sections are avoided by the two drive units.

Further exemplary embodiments show that the first suspension means section is coupled to the second suspension means section by means of a compensating element. In particular, the first suspension means section and/or the second suspension means section can be coupled to the elevator car and/or to the counterweight by means of a compensating element. The fact that the first suspension means section is coupled to the second suspension means section should also include a connection of at least one of the two suspension means sections to the elevator car or the counterweight by means of the compensating element. In this case, the connection between the suspension means sections is then implemented via the elevator car or the counterweight. The compensating element comprises for example one or more deflecting rollers, a rocker, a spring, a rubber element or a (third) suspension means section or any combination of the aforementioned possible compensating elements. However, it is advantageous if either the connection between the suspension means sections and the elevator car or between the suspension means sections and the counterweight is fixed or rigid, that is to say has the absence of a compensating element.

In addition, it is advantageous that the compensating element is quasistatic. This means that under ideal conditions, that is to say in particular with exactly the same properties of the first and second suspension means sections, the same temperature of both suspension means sections, etc., the compensating element does not move, and thus would be superfluous. Under real conditions, however, there are fluctuations in the length of the suspension means sections over the service life of the elevator installation, for example caused by the loading on the suspension means or by temperature differences, wherein the fluctuation in the length of the first suspension means section typically differs from the fluctuations in the length of the second suspension means section. In this case, it is advantageous that this fluctuation in the length of the suspension means sections is compensated for by the compensating element. In this way, stresses in the suspension means sections can be reduced.

In exemplary embodiments, the first suspension means section and the second suspension means section are each implemented by way of a separate suspension means. In an alternative exemplary embodiment, the first suspension means section and the second suspension means section are implemented by way of a common suspension means. The first suspension means section and the second suspension means section are then (mechanically) connected to one another, in particular in the region of the compensating element, in order to form the common suspension means. For example, the common suspension means may be a rope, a chain or belt, which is arranged on one or more deflecting rollers as compensating element, and is thus connected to the elevator car via the at least one deflecting roller. Such an arrangement of the suspension means is inexpensive and easy to implement.

In exemplary embodiments, the elevator installation also has a further (that is to say second) elevator car in the shaft, said further elevator car being able to be moved independently of the (first) elevator car by means of a second drive unit. In other words, the elevator installation is a multi-cabin elevator system. The further elevator car can therefore use the same guideway as the (first) elevator car. Optionally, the further elevator car can use the same running rails (or guide rails) as the first elevator car. In the case of a multi-cabin elevator system, the need to design the suspension of the at least two elevator cars to be as space-saving as possible is even greater. It is not uncommon for conventional suspensions of multi-cabin elevator systems to require three levels (in particular floors) to accommodate the suspension and the drive unit(s) for the elevator cars. These three levels then cannot be reached with this elevator system. This means that in order to get to the top floors, people either have to walk or change the means of transport, that is to say for example change to another elevator installation or to an escalator. With the suspension according to the invention, however, it is possible for the levels provided for the suspension and the drive units to be able to be reduced at least to two levels, and with a clever arrangement also to even one level. The number of people who then have to change from the elevator installation to get to their destination is thus significantly reduced.

In exemplary embodiments, the (first) elevator car is arranged below the further (second) elevator car. The first suspension means section and the second suspension means section can then be guided on the elevator car in such a way that the first and the second suspension means section run outside a travel path of the further elevator car. In particular, both suspension means sections should run completely, that is to say over their entire length, outside the travel path of the further elevator car. It is thus not possible for a collision between the further elevator car and the suspension means that hold the (first) elevator car to occur.

Exemplary embodiments also show the further elevator car with a suspension that differs from the suspension of the (first) elevator car, in particular the suspension of the further elevator car is of a different type of suspension to the suspension of the elevator car. The elevator car can be connected to the counterweight for example by means of the suspension according to the invention having two suspension means sections, while the further elevator car is connected to the counterweight by means of a typical 1:1 suspension. It is also possible to replace one of the two suspensions, in particular the suspension of the further elevator car, with a higher-ratio suspension, for example a 2:1 or a 3:1 suspension. It is advantageous that the two suspensions differ from one another, since the suspension of the two elevator cars can thus be arranged offset from one another. This is a feature that allows the suspension of the elevator installation to be implemented in a compact manner, that is to say with a small structural shape.

In exemplary embodiments, the first and/or the second suspension have/has a first and a second deflecting roller, which are arranged in a common level, in order to deflect the second suspension means section from the elevator car to the counterweight. The term deflecting roller relates to any means that allows the suspension means section to be deflected from a first, in particular vertical direction into a second, for example horizontal direction. This is advantageous compared with arrangements of elevator installations in which, for example, a suspension means section is first brought together with another suspension means section via deflecting rollers in order to then be able to jointly drive both suspension means sections. The bringing-together of the two sub-sections typically takes up an entire level, for example in order to make the distance between successive bending cycles as large as possible and to stress the suspension means section as little as possible.

In exemplary embodiments, the second drive unit of the further elevator car and the drive unit of the elevator car are arranged on a common level, in particular a common floor of the building in which the elevator installation is installed. In a further exemplary embodiment, the two drive units are also arranged on the same level as the first and second deflecting rollers of the first and/or second 1:1 suspension. It is furthermore also possible to arrange the drive unit (or the second drive unit) together with the first and the second deflecting roller of the first and of the second 1:1 suspension on a first common level and to arrange the second drive unit on a second level. The drive units can also be interchanged. In particular, all deflecting rollers that are required to deflect the first and second suspension means sections, and also the (first) drive unit of the (first) elevator car and the second drive unit of the further elevator car, can be arranged on one level, in particular on a common floor of the building in which the elevator installation is installed.

In other words, deflecting rollers for deflecting the first suspension means section from the elevator car via the drive unit to the counterweight and for deflecting the second suspension means section from the elevator car to the counterweight can be arranged in a common level, wherein the common level is in particular the same level in which the drive unit of the elevator car and/or the second drive unit of the further elevator car are/is also arranged. In this case, the term deflecting rollers relates to both the one or more deflecting rollers of the first 1:1 suspension and the one or more deflecting rollers of the second 1:1 suspension. However, it is advantageous for the construction of a multi-cabin elevator system if at least one of the two 1:1 suspensions has at least two deflecting rollers, since this makes it possible for the suspension means to be guided outside the travel path of the other elevator car. In general, it is also possible here to use suspensions of a higher-ratio than the 1:1 suspensions described, but the 1:1 suspensions offer the greatest space savings.

In exemplary embodiments, at least the first and/or the second suspension have/has a first and a second deflecting roller. The first and the second deflecting roller are at a (horizontal) distance from one another which is greater than a distance between the elevator car and the counterweight. This makes it possible for the suspension means of one of the two suspension means sections to be guided on a side, facing away from the counterweight, of the elevator car and of the further elevator car outside the travel path of the further elevator car, and for this suspension means section to be guided via the first and second deflecting rollers to the counterweight. In this way, the further elevator car can be moved below the elevator car independently of the elevator car. This enables the creation of a multi-cabin elevator system that is driven by way of suspension means.

In exemplary embodiments, the first suspension means section and/or the second suspension means section have/has the absence of a reverse bending cycle. A reverse bending cycle is understood to mean a change from the bent state to the straight state and back to an oppositely bent state of a suspension means. An oppositely bent state is also present if the suspension means is bent on one level into the next level. A bending cycle also denotes any bend or deflection of the suspension means by at least 40°, at least 60°, or at least 80°. Since reverse bending cycles have a negative impact on the service life of the suspension means, it is advantageous to reduce reverse bending cycles as much as possible. In exemplary embodiments, it is possible to reduce the number of reverse bending cycles in the first and second suspension means sections to a maximum of two or even only one, the maximum two reverse bending cycles being limited to one suspension means section and the other suspension means section being free from reverse bending cycles.

Furthermore, a method for operating an elevator installation is shown, comprising the following steps: arranging an elevator car in a shaft, wherein the elevator car is connected to a counterweight, wherein the connection comprises a first suspension having a first suspension means section and a second suspension having a second suspension means section; and moving the elevator car by means of a drive unit that drives the first suspension.

Preferred exemplary embodiments of the present invention are explained below, with reference being made to the attached drawings. In the drawings:

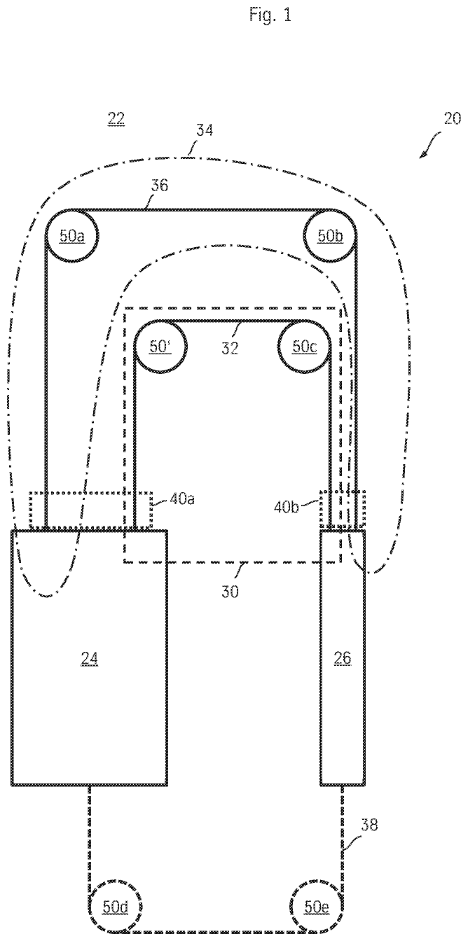

FIG. 1 shows a schematic illustration of an elevator installation;

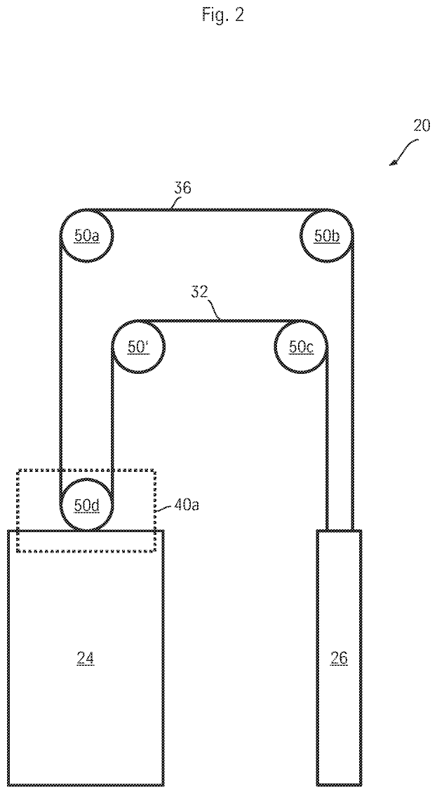

FIG. 2 shows a side view of a schematic illustration of the elevator installation with a compensating element in a first embodiment;

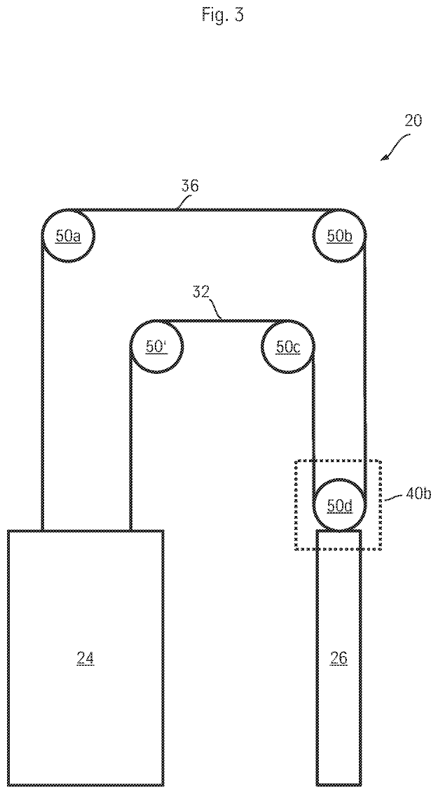

FIG. 3 shows a side view of a schematic illustration of the elevator installation with the compensating element in a second embodiment;

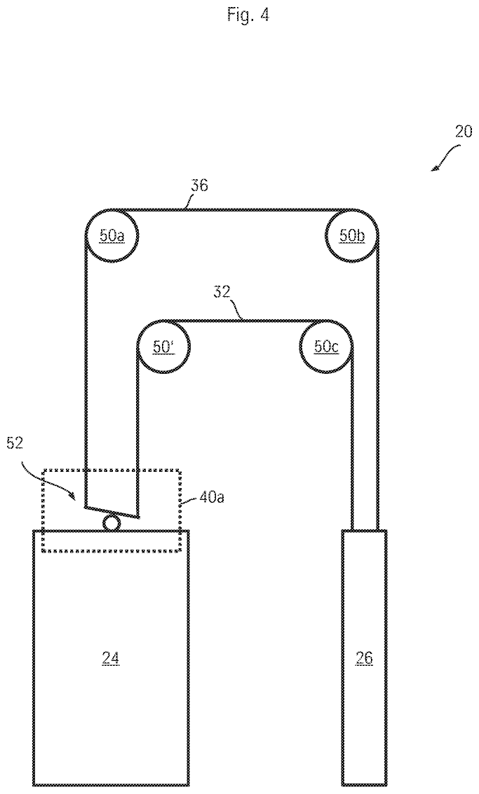

FIG. 4 shows a side view of a schematic illustration of the elevator installation with the compensating element in a third embodiment;

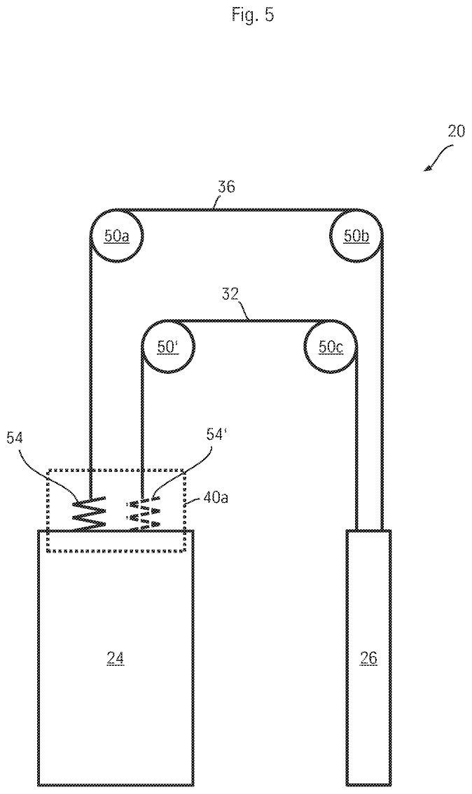

FIG. 5 shows a side view of a schematic illustration of the elevator installation with the compensating element in a fourth embodiment;

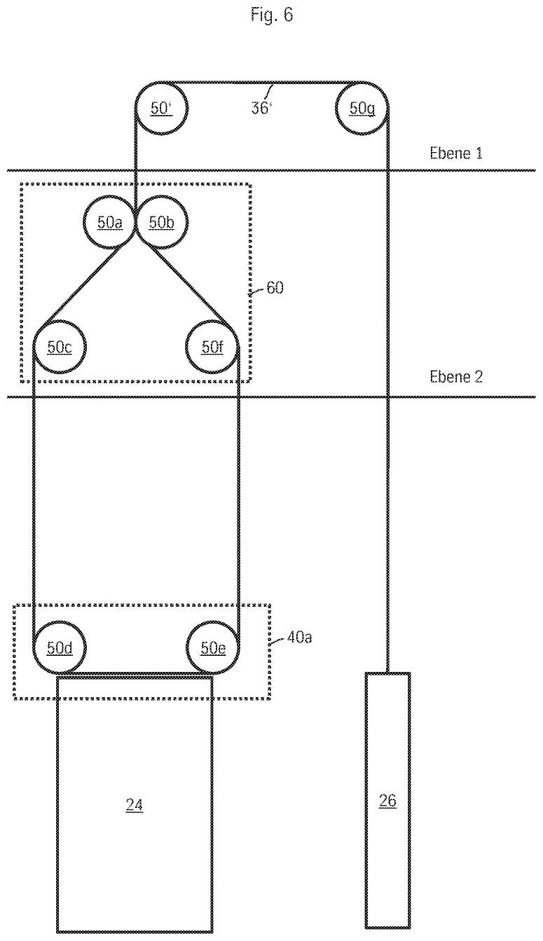

FIG. 6 shows a side view of a schematic illustration of the elevator installation with a known suspension of a lower elevator car of a multi-cabin elevator system;

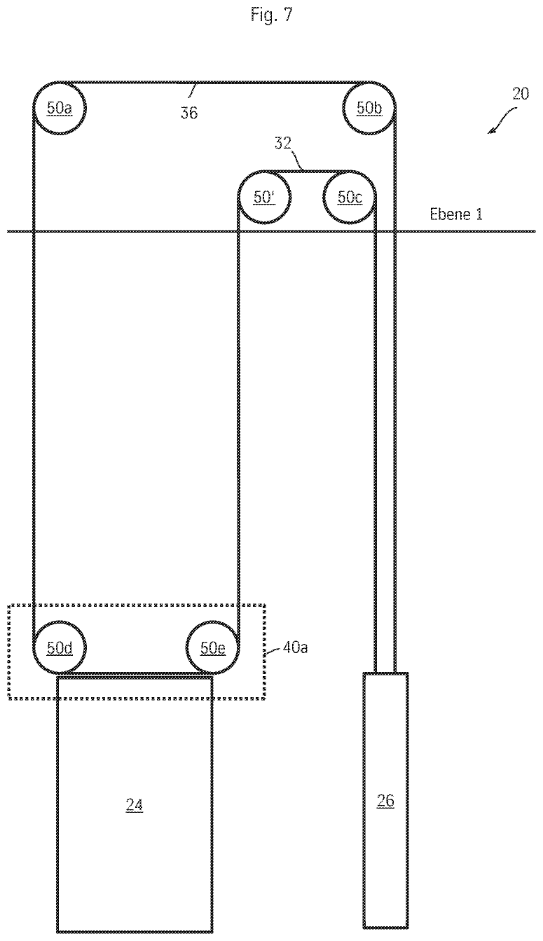

FIG. 7 shows a side view of a schematic illustration of the elevator installation with the compensating element in a fifth embodiment, which can be used, for example, for the lower elevator car of a multi-cabin elevator system;

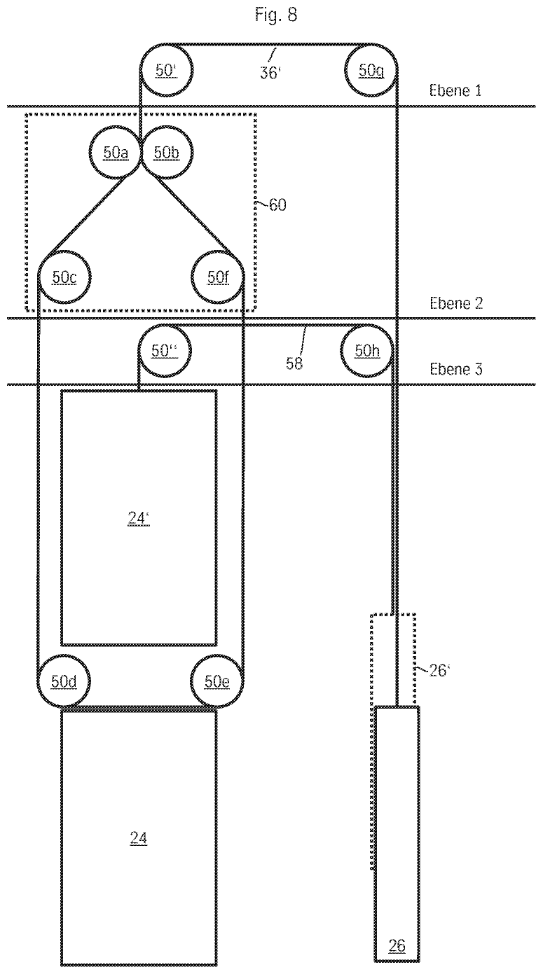

FIG. 8 shows a side view of a schematic illustration of a known multi-cabin elevator system;

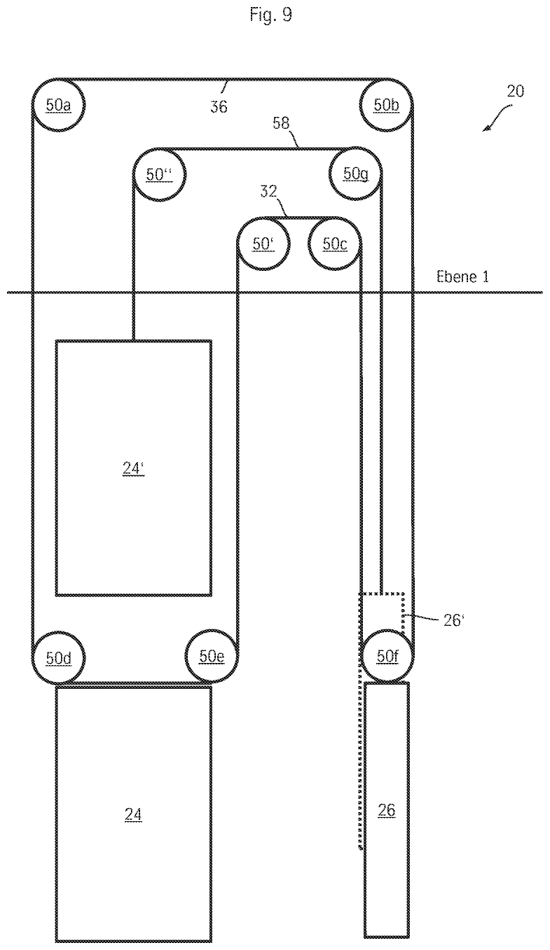

FIG. 9 shows a side view of a schematic illustration of the elevator installation in an embodiment as a multi-cabin elevator system, the lower elevator car having the suspension according to the invention; and

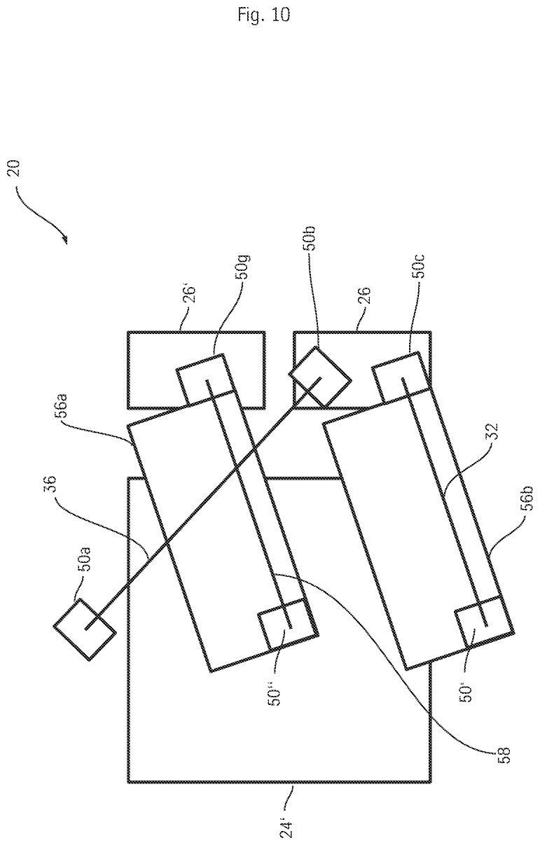

FIG. 10 shows a plan view of a schematic illustration of the elevator installation from FIG. 9.

Before exemplary embodiments of the present invention are more closely explained in detail below on the basis of the drawings, attention is drawn to the fact elements, objects and/or structures that are identical, functionally equivalent or have the same effect are provided with the same reference designations in the various figures, and so the description of these elements presented in the different exemplary embodiments is interchangeable with one another or can be applied to one another.

FIG. 1 shows a side view of a schematic illustration of an elevator installation 20. The elevator installation 20 has a shaft 22, an elevator car 24 arranged therein and a counterweight 26 likewise arranged in the shaft 22. The elevator car 24 is (mechanically) connected to the counterweight 26. The connection between the elevator car 24 and the counterweight 26 is implemented via two suspensions, two 1:1 suspensions requiring the least amount of space. In this respect, a 1:1 suspension is always shown in the figures, but it is also possible to replace this with a higher-ratio suspension. The first 1:1 suspension 30 has a first suspension means section 32. The first suspension means section 32 is guided over a traction sheave 50′ and a diverting roller 50c in order to (mechanically) connect the elevator car 24 to the counterweight 26. The second 1:1 suspension 34 has a second suspension means section 36. The second suspension means section 36 is guided over deflecting rollers 50a, 50b in order to (mechanically) connect the elevator car 24 to the counterweight 26. However, the arrangement of the traction sheave 50′ is not limited to the position shown in FIG. 1. Rather, the traction sheave can also be arranged at a different position, for example at one of the points at which the deflecting rollers 50a, 50b and 50c are shown.

Furthermore, the diverting roller 50c can be positioned differently in relation to the traction sheave 50′, for example in order to increase the friction between the traction sheave 50c and the suspension means section 32. To mention just a few examples, the diverting roller 50c can be arranged for example downwardly offset in relation to the traction sheave 50′, and/or the suspension means section 32 can wrap around both the diverting roller 50c and traction sheave 50′ together once or several times.

The elevator installation 20 optionally has a compensating element in order to couple the first 1:1 suspension 32 to the second 1:1 suspension 36. The compensating element can be arranged on the elevator car 24, that is to say for example in a (first) position 40a, or on the counterweight 26, that is to say for example in a (second) position 40b. Examples of different compensating elements are shown in the following figures.

Optionally, the elevator installation also has a lower guide 38 (for example a compensation rope or a compensation chain), with which the lower sides of the elevator car 24 and of the counterweight 26 are connected to one another. The compensation rope 38 can be guided and optionally tensioned by means of the deflecting rollers 50d, 50e.

FIG. 2 shows the elevator installation 20 according to one exemplary embodiment. In contrast to FIG. 1, the elevator installation 20 has a further deflecting roller 50d as a compensating element in position 40a. In this exemplary embodiment, the first and second suspension means sections 32, 36 are advantageously implemented from a single suspension means. In this case, the common suspension means can be guided around the deflecting roller 50d, so that in the case of a different extension of the first suspension means section 32 relative to the second suspension means section 36, the deflecting roller 50d moves, in particular rotates, in order to compensate for the different extension. Alternatively, the first and second suspension means sections 32, 36 can also be fastened to the deflecting roller 50d in some other way than by the guiding-around of the suspension means, so that it is also possible to implement this arrangement with two suspension means sections 32, 36 that are separate from one another.

FIG. 3 shows the elevator installation 20 in a further exemplary embodiment. In contrast to FIG. 2, the further deflecting roller 50d is arranged not in position 40a but in position 40b, that is to say on the counterweight 26. Otherwise, the statements from FIG. 2 can also be applied to the exemplary embodiment from FIG. 3.

FIG. 4 shows the elevator installation 20, which differs in comparison to the exemplary embodiment from FIG. 2 in terms of the type of compensating element. Instead of the deflecting roller, a rocker 52 is arranged at position 40a. The rocker 52 fulfills the same purpose as the deflecting roller 50d from FIG. 2. This applies in particular to the exemplary embodiment from FIG. 2, in which two separate suspension means are used to form the first suspension means section 32 and the second suspension means section 36. Just like the deflecting roller from FIG. 2 can also be arranged at position 40b (see FIG. 3), the rocker 52 can also be arranged at position 40b, that is to say on the counterweight 26.

FIG. 5 shows the elevator installation 20 in an exemplary embodiment with a spring 54 and optionally a further spring 54′ as compensating element. The exemplary embodiment from FIG. 5 differs from the exemplary embodiments from FIG. 1 to FIG. 4 only in terms of the selection of the compensating element. The spring 54 is arranged between the second suspension means 36 and the elevator car 24. Since the first suspension means 32 is also arranged in the elevator car, the spring 54 is also arranged between the first suspension means 32 and the second suspension means 36, so that the first suspension means 32 is coupled to the second suspension means 36 by means of the spring 54. In addition or as an alternative, the first suspension means section 32 can also be connected to the elevator car 24 by means of a spring. The further spring 54′ can be arranged between the first suspension means 36 and the elevator car 24 in a manner analogous to the spring 54. Further possible compensating means are shown in the laid-open specification WO 2006 097 138 A1.

FIG. 6 shows a known arrangement of a lower elevator car 24 in a multi-cabin elevator system. The compensating element at position 40a has two deflecting rollers 50d and 50e. The deflecting rollers 50d and 50e are arranged on an elevator car 24 in such a way that the suspension means 36 is (vertically) guided outside a travel path of the elevator car 24. In this exemplary embodiment, the suspension means 36′ is divided into two strands in a roller block 60, one (first) strand being guided via the deflecting roller 50c to the elevator car 24 and the other (second) strand via the deflecting roller 50f to the elevator car 24. The roller block 60, however, occupies an entire level, for example an entire floor, and accordingly requires a lot of space. This arrangement is shown in the laid-open specification WO 2006 097 140 A1.

FIG. 7 shows the elevator installation 20 with an alternative suspension of the elevator car 24. The elevator installation 20 is in particular a multi-cabin elevator system having the suspension according to the invention. In comparison to FIG. 6, the exemplary embodiment from FIG. 7 has the absence of the roller block 60. However, the arrangement of the deflecting rollers 50d and 50e is not changed in relation to FIG. 6. By omitting the division of the suspension means 36′ into two strands, it is also possible to dispense with the roller block 60, in which the strands would otherwise have to be brought together so that they could be guided together via the drive unit. The deflecting rollers 50a, 50b and 50c and the traction sheave 50′ can also be arranged in a single level. The second level for the roller block from FIG. 6 can be omitted.

In addition to saving space, the exemplary embodiment from FIG. 7 also has the advantage over the elevator installation from FIG. 6 that the suspension means having the two suspension means sections 32 and 36 does not undergo a reverse bending cycle. The change in curvature between the deflecting roller 50e and the traction sheave 50′ is not regarded as a reverse bending cycle on account of the large distance between the deflecting roller 50e and the traction sheave 50′, since the typical factors that a reverse bending cycle entails, in particular the higher stress on the suspension means in comparison to a simple bending cycle, do not apply here.

By contrast, the suspension means from FIG. 6 is subjected to a reverse bending cycle between the deflecting rollers 50f and 50b and 50c and 50a, respectively. Furthermore, proceeding from the deflecting rollers 50a and 50b to the traction sheave 50′, the suspension means undergoes at least one further reverse bending cycle if as much space as possible is to be saved. The suspension means 36′ is therefore more heavily stressed than the suspension means from FIG. 7 having the suspension means sections 32 and 36 due to the larger number of reverse bending cycles. A further advantage of the exemplary embodiment from FIG. 7 over the elevator system from FIG. 6 is the lower force effect of the elevator car on the traction sheave 50′, that is to say a lower mechanical loading of the traction sheave 50′ or overall of the drive unit that drives the traction sheave 50′. The drive unit can thus be of (mechanically) smaller configuration and nevertheless (with the same power consumption) move the same elevator car, that is to say in particular an elevator car with the same weight.

The exemplary embodiment from FIG. 7 also shows that the second suspension means section 36 is guided over two deflecting rollers 50a, 50b in order to form the second 1:1 suspension. The two deflecting rollers 50a and 50b are advantageously at a distance from one another which is greater than a distance between the elevator car 24 and the counterweight 26. It is thus possible to guide the suspension means section 36 from the elevator car 24 to the counterweight 26, and in the process bridge, for example traverse, the first 1:1 suspension.

FIG. 8 shows the multi-cabin elevator installation from FIG. 6, the upper elevator car 24′ being additionally illustrated here. While the lower elevator car 24 is driven by means of the traction sheave 50′, the upper elevator car 24′ is driven by means of the traction sheave 50″. The lower elevator car 24 is suspended from the suspension means 36′ at one end. At its other end, the suspension means 36′ is connected to the counterweight 26. The upper elevator car 24′ is connected to the further counterweight 26′ by way of the further suspension means 58. It becomes clear here that three levels are required for the arrangement of the suspension for both elevator cars 24, 24′.

FIG. 9 shows one exemplary embodiment of a multi-cabin elevator system having the suspension according to the invention that can replace the multi-cabin elevator system from FIG. 8. In other words, the exemplary embodiment from FIG. 9 shows the multi-cabin elevator system from FIG. 7, wherein an (upper) elevator car 24′ is also shown which is arranged above the lower elevator car 24 and which can be moved in particular independently of the lower elevator car 24. The upper elevator car 24′ is connected to a further counterweight 26′ by way of the further suspension means 58. The upper elevator car 24′ is driven via the further traction sheave 50″. For example, the type of suspension of the upper elevator car 24′ of the exemplary embodiment from FIG. 9 can be the same as the type of suspension of the upper elevator car 24′ of the exemplary embodiment from FIG. 8. However, a spatial arrangement of the deflecting rollers and the guidance of the suspension means 58 in terms of depth, that is to say perpendicular to the plane of the drawing, can differ from the multi-cabin elevator system from FIG. 8. An exemplary arrangement is described below in FIG. 10.

FIG. 10 shows a plan view of the multi-cabin elevator system from FIG. 9, which illustrates a possible spatial arrangement of the deflecting rollers 50 and drive units 56 and of the guidance of the suspension means 58 and of the suspension means sections 32, 36. The suspension means 36 can thus be guided above the drive unit 56a which drives the further traction sheave 50″ and thus moves the upper (second) elevator car 24′. The drive unit 56b which drives the traction sheave 50′ and can thus move the lower (first) elevator car 24 can be arranged offset, for example in a parallel manner, with respect to the drive unit 56a. The drive unit 56a is also referred to as the second drive unit. The first traction sheave 50′ and the deflecting roller 50a can be arranged in such a way that the first suspension means section 32 and the second suspension means section 36 are guided past opposite sides next to the upper elevator car 24′ in order to reach the lower elevator car 24. The traction sheave 50″ can be arranged centrally above the upper elevator car 24′. The suspension means 58 can be guided perpendicular to the center, for example a center of gravity, of the elevator car 24′. Such a spatial arrangement of the deflecting rollers and of the associated spatial guidance of the suspension means makes it possible for both drive units 56a and 56b, the suspension for the upper elevator car 24′ and the first and the second 1:1 suspension for the lower elevator car 24 to be arranged in one level, in particular one floor.

Even though some aspects have been described in conjunction with an apparatus, it is understood that these aspects also represent a description of the corresponding method, and so a block or component of an apparatus should also be understood to be a corresponding method step or a feature of a method step. In a manner analogous thereto, aspects that have been described in conjunction with, or as, a method step also represent a description of a corresponding block or detail or feature of a corresponding apparatus.

The above-described exemplary embodiments represent only an elucidation of the principles of the present invention. It is understood that modifications and variations of the arrangements and details described herein will be evident to other persons skilled in the art. Therefore, the intention is that the invention is restricted only by the scope of protection provided by the patent claims below and not by the specific details that have been presented herein on the basis of the description and the explanation of the exemplary embodiments.

### LIST OF REFERENCE DESIGNATIONS

20 Elevator installation
22 Shaft
24 Elevator car
26 Counterweight
30 First (1:1) suspension
32 First suspension means section
34 Second (1:1) suspension
36 Second suspension means section
38 Lower guide
40 Compensating element
50 Deflecting roller
50′ Traction sheave
52 Rocker
54 Spring
56 Drive unit
58 Suspension means for the further elevator car
60 Roller block

1.-16. (canceled)

17. An elevator installation comprising:
an elevator shaft;
a first elevator car disposed in said elevator shaft;
a counterweight operatively connected to said elevator car by a first suspension having a first suspension means section, and by a second suspension having a second suspension means section;
a first drive unit in operative communication with said first suspension and configured to move said first elevator car by said first suspension;
a second elevator car disposed in said elevator shaft; and
a second drive unit configured to move said second elevator car, independently of said first elevator car.

18. The elevator installation of claim 17, wherein said second suspension is free of said first drive unit.

19. The elevator installation of claim 17, further comprising a third drive unit configured to drive said second suspension to move said car in cooperation with said first drive unit.

20. The elevator installation of claim 17, wherein said first suspension means section is coupled to said second suspension means section by a compensating element.

21. The elevator installation of claim 20, wherein said compensating element includes one or more of a deflecting roller, a rocker, a spring, a rubber element, or a suspension means section.

22. The elevator installation of claim 17, wherein the first suspension means section and the second suspension means section are each separate individual suspension means.

23. The elevator installation of claim 17, wherein said first suspension means section and said second suspension means section are a common suspension means, and are connected to one another in a region of a compensating element.

24. The elevator installation of claim 17, wherein said first elevator car is disposed below said second elevator car, wherein said first suspension means section and said second suspension means section are guided to said first elevator car such that said first and second suspension means sections each run outside a travel path of said second elevator car.

25. The elevator installation of claim 17, wherein said second elevator car has a third suspension which differs from said first and second suspensions of said first elevator car.

26. The elevator installation of claim 17, wherein said second drive unit of said second elevator car and said first drive unit of said first elevator car are disposed on a common level.

27. The elevator installation of claim 17, wherein at least one of said first or said second suspension comprises:
a first deflecting roller and a second deflecting roller both disposed on a common level and configured to deflect said second suspension means section from said first elevator car to said counterweight.

28. The elevator installation of claim 27, wherein at least one of said first drive unit or said second drive unit is also disposed on the common level.

29. The elevator installation of claim 17, further comprising:
deflecting rollers configured to deflect said first suspension means section from said first elevator car to said counterweight and deflect said second suspension means section from said first elevator car to said counterweight, said deflecting rollers being disposed on a common level.

30. The elevator installation of claim 29, wherein at least one of said first drive unit or said second drive unit are also disposed on the common level.

31. The elevator installation of claim 17, wherein at least one of said first suspension or said second suspension comprises a first deflecting roller and a second deflecting roller disposed at a distance from each other that is greater than a distance between said first elevator car and said counterweight.

32. The elevator installation of claim 17, wherein at least one of said first suspension means section or said second suspension means section is free of a reverse bending cycle.

33. A method of operating an elevator installation, comprising:
arranging a first elevator car in a shaft, wherein the first elevator car is connected to a counterweight by a first suspension having a first suspension means section and a second suspension having a second suspension means section;
driving the first suspension by a drive unit to move the first elevator car in the shaft;
arranging a second elevator car in the shaft; and
moving the second elevator car independently of the first elevator car by use of a second drive unit.
